(19) United States
(12) Patent Application Publication
(10) Pub. No.: US 2003/0236064 A1
(43) Pub. Date: Dec. 25, 2003

(54) Wireless communication device

(75) Inventors: Susumu Shiohara, Nagano-ken (JP); Teruhito Kojima, Nagano-ken (JP)

Correspondence Address: SUGHRUE MION, PLLC, 2100 Pennsylvania Avenue, NW, Washington, DC, 20037-3213, US

(73) Assignee: SEIKO EPSON CORPORATION

(21) Appl. No.: 10/364,676

(22) Filed: Feb. 12, 2003

(30) Foreign Application Priority Data
Feb. 12, 2002 (JP) 2002-34322(P)
Feb. 21, 2002 (JP) 2002-44899(P)

(51) Int. Cl. H04K 3/00

(52) U.S. Cl. 455/1; 455/550.1

(57) ABSTRACT

The technique of the present invention prevents troubles, such as the lowered baud rate, in wireless communication.

In a wireless LAN connecting with multiple devices, when a baud rate between two devices is lowered to or below a preset level, the procedure of a first arrangement compares MAC addresses of the two devices and switches over the communication channel of a device having the smaller MAC address, while keeping the communication channel of a device having the greater MAC address.

When the baud rate is lowered to or below the preset level, the procedure of a second arrangement temporarily switches over the working communication channel from an original communication channel to another communication channel. When wireless communication in a predetermined unit is completed, the procedure makes a re-switchover to the original communication channel.

### BACKGROUND OF THE INVENTION

1. Field of the Invention

The present invention relates to a technique of controlling a communication channel to ensure smooth communication in a wireless communication device.

2. Description of the Related Art

Wireless LANs (local area networks) are widely used, where multiple computers and peripheral devices like printers are connected wirelessly via radio waves. The respective devices entering the wireless LAN establish wireless communication at a preset communication channel. For example, the international standard IEEE 802.11 allows for selection of an arbitrary channel among 14 communication channels as a working channel.

In the prior art system, the administrator manually sets the communication channel. The expanded scale of the network naturally increases the burden on the administrator. Inadequate setting of the communication channel may lead to the interference of communication and the lowered baud rate.

For example, the increased number of devices using an identical communication channel makes the traffic heavier and may significantly lower the baud rate. Selection of a communication channel in poor communication state may also cause the lowered baud rate.

The heavier traffic and the worsened communication state may induce various troubles, such as lack of some bits, in addition to the lowered baud rate.

The preset communication channel may be switched over to a communication channel used by a less number of devices or a communication channel in a good communication state. In the case where a large number of devices enter the wireless LAN, however, such switchover of the setting takes significant time and labor. When a number of devices switch over the setting to another identical communication channel, the heavy traffic may not be eliminated even after the switchover.

The technique of the international standard IEEE 802.11 can adopt the roaming function to distribute a number of devices entering the wireless LAN to multiple communication channels. This technique, however, requires relay devices called access points according to the number of working communication channels.

### SUMMARY OF THE INVENTION

The object of the present invention is thus to solve the drawbacks of the prior art technique and to prevent troubles in wireless communication.

In order to attain at least part of the above and the other related objects, the present invention is directed to a first wireless communication device, which includes: an identification information storage module that stores identification information, which is used to identify the wireless communication device; a channel setting module that sets a channel used for wireless communication; a wireless communication module that establishes wireless communication at the channel set by the channel setting module; a trouble detection module that utilizes a radio signal received by the wireless communication module to detect a trouble in communication; an identification information detection module that detects identification information of another wireless communication device, which has transmitted the radio signal, from the received radio signal; and a trouble avoidance module that carries out a predetermined avoidance operation to avoid the detected trouble according to a preset condition, which is set based on a relation between the identification information stored in the identification information storage module and the detected identification information.

Various methods are applicable to detect a trouble in communication. For example, one applicable method expects a trouble when receiving a radio signal at a channel conflicting with the channel set by the channel setting module. Another applicable method expects a trouble when detecting a decrease in baud rate in transmission and reception of the radio signal. Still another applicable method expects a trouble when detecting an increase in density of the radio signal received per unit time. The first wireless communication device may detect a future or potential trouble in communication. For example, the device estimates the maximum possible traffic at the time of a potential communication burst according to the number of other wireless communication devices set in a communicable state, and determines whether or not there is a possibility of causing a trouble in communication, based on the estimated traffic.

A radio signal transmitted from another wireless communication device may be used to detect the trouble in communication. Examples of such radio signal include a radio signal transmitted and received in the course of ordinary communication, an inherent signal used to identify a trouble, and a beacon signal periodically transmitted from another wireless communication device.

In the case of detection of a trouble in communication, the first wireless communication device carries out the avoidance operation to avoid the trouble. The trouble avoidance operation is performed in a well-ordered manner according to a predetermined rule through comparison between the own identification information and the identification information of another wireless communication device. This arrangement prevents the two wireless communication devices from carrying out avoidance operations in an ill-ordered manner, thus ensuring normal communication.

In one example of the first wireless communication device, the identification information is numeric information, and the preset condition is set based on a magnitude relation of the identification information. This arrangement ensures objective and unique setting of the condition. For example, the setting of the condition may control execution of the avoidance operation to make the wireless communication device having the greater identification information carry out the avoidance operation, while making the wireless communication device having the smaller identification information keep the current setting. The control may be inversed to make the wireless communication device having the smaller identification information carry out the avoidance operation. In another example, the respective wireless communication devices may carry out different avoidance operations, based on the magnitude relation.

The numeric information may be expressed in any of diverse notations, for example, binary notation, decimal notation, or hexadecimal notation. The numeric information is preferably information uniquely allocated to the wireless communication device, for example, an MAC address or an IP address, or a serial number assigned to the wireless communication device by its manufacturer.

The preset condition is not restricted to the magnitude relation of the numeric information, but may be set based on the result of detection, whether the end of the identification information is an even or an odd or whether the end of the identification information is equal to 1 or equal to 0. Another example of the preset condition is three-way strong-weak relations, that is, the identification information expressed as 3n+2 (where n is a natural number) is stronger than the identification information expressed as 3n+1, the identification information expressed as 3n+1 is stronger than the identification information expressed as 3n, and the identification information expressed as 3n is stronger than the identification information expressed as 3n+2.

In the first wireless communication device, the preset avoidance operation may be an operation of causing the channel setting module to switch over a current setting of the channel to another channel. In this application, the first wireless communication device switches over the own channel, in order to avoid conflict with the working channel in another wireless communication device. The another channel as a switchover destination may be set by detecting a vacant channel in advance or may be set according to a predetermined sequence.

In one preferable application of the first wireless communication device, the wireless communication module has a terminal communication function to make communication as a terminal and a relay communication function to receive a radio signal output from another wireless communication device and transmit the received radio signal to another wireless communication device. The first wireless communication device further includes a communication function switchover module that switches over a working communication function between the two communication functions. The preset avoidance operation gives the communication function switchover module an instruction of switching over the working communication function from the relay communication function to the terminal communication function.

This application switches over the communication function or the communication mode to avoid a trouble in communication. For example, in the case of detection of a trouble in communication, a personal computer or a wireless print server, which is capable of acting as either of an access point and a station in a wireless network, stops the functions as the access point and works as one station of another access point.

The present invention is also directed to a second wireless communication device, which includes: a communication module that establishes wireless communication at a preset communication channel; a decision module that determines whether or not a switchover condition, which is set relating to at least one of contents of the wireless communication and a state of the wireless communication, is fulfilled; a switchover module that, when the switchover condition is fulfilled, makes a switchover from the preset communication channel to another communication channel and gives a switchover instruction to a partner of the wireless communication; a settings storage module that stores settings relating to the preset communication channel at a time of the switchover; and a re-switchover module that makes a re-switchover from the another communication channel to the preset communication channel stored in the settings storage module, when wireless communication in a predetermined unit is completed at the another communication channel.

The second wireless communication device of the present invention is preferably applied to a wireless communication network to which multiple devices are connected by wireless, for example, a wireless LAN. The technique of this device switches over the communication channel in the case of fulfillment of the switchover condition, and makes a re-switchover to the original communication channel used before the switchover on completion of communication in the predetermined unit. In response to the switchover instruction, the communication channel is also switched over in the partner of the wireless communication. There may be multiple partners. For example, in the case where two wireless communication devices establish wireless communication via a relay device, the communication channel may be switched over in both the relay device and the other wireless communication device.

The ‘predetermined unit’ represents a unit of some massed data, for example, a file unit. In the case where the partner of the wireless communication is a wireless print server, the predetermined unit may be a print job unit. A communication channel in a frequency band that does not mutually interfere with the ‘original communication channel used before the switchover’ is selected as ‘another communication channel’.

The settings storage module may store the settings of the original communication channel permanently or otherwise temporarily only at the time of switchover. The requirement is that the original communication channel is to be held in a state of allowing a re-switchover at least for a valid time of the switchover.

The second wireless communication device may temporarily switch over the communication channel to establish wireless communication with a specific partner. This arrangement ensures establishment of wireless communication at a communication channel other than those of heavy traffic and those in poor communication state. The switchover of the communication channel is only temporary, and a re-switchover to the original communication channel is made on completion of communication in a predetermined unit. Wireless communication with another wireless communication device using the original communication channel can thus be established after the re-switchover.

In the second wireless communication device of the present invention, the switchover condition is set, for example, based on a baud rate of the wireless communication.

The communication channel is switched over in response to a decrease in baud rate. This arrangement prevents the baud rate from being undesirably lowered.

The switchover condition may otherwise be set, based on the communication protocol applied, the partner of communication, or the quantity of data. The partner of communication is identifiable, for example, by the MAC address, the IP address, or the name of the communication device. These switchover conditions enable the communication channel to be selectively used according to the application of communication or the partner of communication.

In one preferable application of the present invention, the second wireless communication device further includes a changed settings memory module that stores in advance settings relating to the another communication channel. The switchover module makes the switchover, based on the settings stored in the changed settings memory module.

This arrangement attains high-speed and easy switchover of the communication channel.

In another preferable application of the present invention, the second wireless communication device further includes a retrieval module that retrieves a communication channel of getting around the switchover condition. The switchover module uses the retrieved communication channel as the another communication channel.

This application retrieves a communication channel in good communication state and uses the retrieved communication channel for wireless communication. In the case where the switchover condition is set based on the baud rate, the procedure may retrieve a communication channel with a sufficient baud rate. The procedure may retrieve a communication channel adopted by a less number of devices.

In one preferable embodiment of the second wireless communication device of the invention, the communication module establishes wireless communication in a preset communication mode. The switchover module makes a switchover from the preset communication mode to another communication mode. The settings storage module stores the preset communication mode. The re-switchover module makes a re-switchover to the preset communication mode.

The ‘communication mode’ here includes an infrastructure mode and an Ad-hoc mode used in wireless communication in conformity with the international standard IEEE 802.11. In the infrastructure mode, wireless communication is established via an access point (relay device). In the Ad-hoc mode, wireless communication is established without an access point. When the communication mode is switched over from the infrastructure mode to the Ad-hoc mode, the switchover of the communication channel is implemented advantageously without a relay device. The communication mode may alternatively be switched over from the Ad-hoc mode to the infrastructure mode.

In another preferable embodiment of the second wireless communication device of the invention, the communication module utilizes preset identification information, which is used to identify a group as a subject of the wireless communication, to establish the wireless communication. The switchover module makes a switchover from the preset identification information to another identification information. The settings storage module stores the preset identification information. The re-switchover module makes a re-switchover to the preset identification information.

The ‘identification information used to identify a group as a subject of the wireless communication’ is, for example, an ESS-ID used in wireless communication in conformity with the international standard IEEE 802.11. In one case, it is assumed that there are multiple wireless LANs that have overlapping communication ranges and are set in the infrastructure mode. The respective wireless LANs generally use different communication channels and different ESS-IDs. The procedure of this embodiment switches over the identification information, as well as the communication channel, so as to temporarily enter another wireless LAN for wireless communication.

The present invention may also be constructed as a wireless communication device, which receives the switchover instruction of the preset communication channel from the second wireless communication device of the present invention discussed above. The present invention is accordingly directed to a third wireless communication device, which includes: a communication module that establishes wireless communication at a preset communication channel; a changed settings memory module that stores in advance settings relating to another communication channel as a switchover destination of the preset communication channel; an instruction input module that inputs a switchover instruction of the preset communication channel from a partner of the wireless communication; a switchover module that makes a switchover from the preset communication channel to the another communication channel, in response to the switchover instruction; a settings storage module that stores settings relating to the preset communication channel at a time of the switchover; and a re-switchover module that makes a re-switchover from the another communication channel to the preset communication channel stored in the settings storage module, when wireless communication in a predetermined unit is completed at the another communication channel.

This arrangement enables the communication channel to be switched over to another communication channel, which is specified in advance by agreement with the partner of communication, for wireless communication, in response to the switchover instruction from the second wireless communication device of the present invention discussed above. The second wireless communication device is then not required to make information of another communication channel as the switchover destination included in the switchover instruction. The switchover instruction is thus advantageously simplified.

The present invention is further directed to a fourth wireless communication device, which includes: a communication module that establishes wireless communication at a preset communication channel; an instruction input module that inputs a switchover instruction of the preset communication channel and settings relating to another communication channel as a switchover destination of the preset communication channel from a partner of the wireless communication; a switchover module that makes a switchover from the preset communication channel to the another communication channel, in response to the switchover instruction; a settings storage module that stores settings relating to the preset communication channel at a time of the switchover; and a re-switchover module that makes a re-switchover from the another communication channel to the preset communication channel stored in the settings storage module, when wireless communication in a predetermined unit is completed at the another communication channel.

This arrangement enables the communication channel to be switched over to another specified communication channel for wireless communication, in response to the switchover instruction from the second wireless communication device of the present invention discussed above. Inclusion of information regarding the communication channel used for establishment of temporary wireless communication in the switchover instruction ensures selective use of diverse communication channels in the temporary wireless communication.

The present invention may otherwise be constructed as a wireless communication device that relays wireless communication between two wireless communication devices. The present invention is accordingly directed to a fourth wireless communication device, which includes: a relay module that relays wireless communication between two wireless communication devices at a preset communication channel; a decision module that determines whether or not a switchover condition, which is set relating to at least one of contents of the wireless communication and a state of the wireless communication, is fulfilled; and a switchover instruction module that, when the switchover condition is fulfilled, gives an instruction of making a switchover from the preset communication channel to another communication channel, to the two wireless communication devices.

The wireless communication device of the present invention is applicable to a relay device in a wireless communication network, for example, to an access point in wireless communication in conformity with the international standard IEEE 802.11. When the switchover condition is fulfilled, this arrangement causes the two wireless communication channels to switch over the working communication channel.

In one preferable application of the present invention, the fifth wireless communication device further includes a second relay module that is capable of relaying wireless communication at a communication channel, which is different from the preset communication channel of the relay module. Here the another communication channel is the communication channel of the second relay module.

This arrangement allows the wireless communication device to relay wireless communication at two different communication channels. The wireless communication device of this application activates the second relay module to relay temporary, wireless communication at the other communication channel, while relaying wireless communication between two other wireless communication devices in an existing wireless communication network.

In the fifth wireless communication device of the invention, the switchover instruction module may give an instruction of switching over a communication mode.

This arrangement enables the two wireless communication devices to directly establish wireless communication without a relay device.

In the fifth wireless communication device of the invention, the switchover instruction module may give an instruction of switching over identification information, which is used to identify a group as a subject of the wireless communication.

This arrangement enables the two wireless communication devices to establish wireless communication using another wireless communication network.

The technique of the present invention is applicable to a wireless server that includes the structure of any one of the third through the fifth wireless communication devices and is connected with one or multiple output devices of images, projected images, or sound, for example, printers or projectors. The arrangement of the present invention desirably prevents a trouble, such as a lowered baud rate, in wireless communication, thus ensuring favorable outputs from these output devices and enhancing the convenience of these output devices.

The technique of the present invention is not restricted to the various wireless communication devices discussed above, but may be actualized as corresponding switchover control methods of controlling switchover of the communication channel in these wireless communication devices. There are a variety of other applications; for example, computer programs to carry out these switchover control methods, recording media in which such computer programs are recorded, and data signals that include such computer programs and are embodied in carrier waves. Any of these applications may have the diversity of additional factors discussed above.

In the case of applications as the computer programs and the recording media in which the computer programs are recorded, the present invention may be constructed as a whole program that actuates the wireless communication device or as a part of the program that attains the functions of the present invention. Typical examples of the recording media include flexible disks, CD-ROMs, DVD-ROMs, magneto-optic discs, IC cards, ROM cartridges, punched cards, prints with barcodes and other codes printed thereon, internal storage devices (memories like a RAM and a ROM) and external storage devices of the computer, and a variety of other computer readable media.

### BRIEF DESCRIPTION OF THE DRAWINGS

FIG. 1 schematically illustrates the construction of an access point 10;

FIG. 2 shows a channel conflict state in two wireless networks;

FIG. 3 is a flowchart showing a conflict avoidance process executed in a first embodiment;

FIG. 4 schematically illustrates the construction of a wireless print server 20;

FIG. 5 is a flowchart showing a conflict avoidance process executed in a second embodiment;

FIG. 6 shows the construction of wireless LANs;

FIG. 7 schematically illustrates the construction of a wireless communication device 10, a wireless print server 20, and an access point 30 in a third embodiment of the present invention;

FIG. 8 is a flowchart showing a wireless communication process between the wireless communication device 10 and the wireless print server 20;

FIG. 9 is a flowchart showing a switchover process of switching over the settings for communication;

FIG. 10 shows a communication state of wireless LANs after re-establishment of wireless communication in the third embodiment;

FIG. 11 is a flowchart showing a re-switchover process;

FIG. 12 shows various applications of the present invention;

FIG. 13 shows a communication state of wireless LANs after re-establishment of wireless communication in a fourth embodiment;

FIG. 14 shows a communication state of wireless LANs after re-establishment of wireless communication in a fifth embodiment; and

FIG. 15 shows a communication state of wireless LANs after re-establishment of wireless communication in a sixth embodiment.

### DESCRIPTION OF THE PREFERRED EMBODIMENTS

Some modes of carrying out the present invention are discussed below as preferred embodiments in the following sequence.

The wireless network in the embodiments discussed hereafter is in conformity with a wireless network standard IEEE 802.11, although another appropriate standard is also applicable.

A. First Embodiment

(A1) General Construction of Access Point

(A2) Wireless Network

(A3) Conflict Avoidance Process

B. Second Embodiment

(B1) General Construction of Wireless Print Server

(B2) Conflict Avoidance Process

C. Modified Examples

D. Third Embodiment

(D1) Construction of Wireless LAN

(D2) Wireless communication Device

(D3) Switchover of Communication Settings

(D4) Various Applications of Invention

E. Fourth Embodiment

F. Fifth Embodiment

G. Sixth Embodiment

H. Seventh Embodiment

I. Modified Examples

A. First Embodiment

(A1) General Construction of Access Point

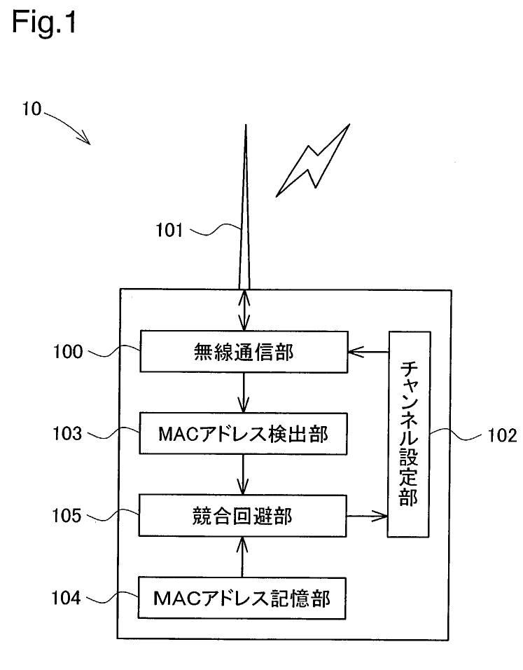

FIG. 1 schematically illustrates the construction of an access point in a first embodiment. The access point relays wireless communication from diverse wireless communication devices in a wireless network. As illustrated, the access point 10 includes a wireless communication module 100, an antenna 101, a channel setting module 102, an MAC address detection module 103, an MAC address storage module 104, and a conflict avoidance module 105.

The wireless communication module 100 uses a channel set by the channel setting module 102 to transmit and receive radio signals via the antenna 101. The wireless communication module 100 also receives beacon signals output from other access points. The beacon signal is output from each access point in a periodical manner and includes information like an MAC address of the access point and an ESS-ID. Reception of a beacon signal from another access point suggests the presence of another access point that uses a channel conflicting with the channel set by the channel setting module 102.

The MAC address detection module 103 analyzes the beacon signal received by the wireless communication module 100 to detect the MAC address of the access point that has transmitted the beacon signal.

The MAC address storage module 104 stores an MAC address allocated uniquely to the access point 10 at the time of factory shipment.

When the preset channel conflicts with the channel of another access point, the conflict avoidance module 105 compares the MAC addresses of the two access points and determines whether or not the preset channel is to be switched over. When it is determined that a switchover of the channel is required, the conflict avoidance module 105 gives the channel setting module 102 an instruction of switching over the preset channel.

These functional modules are actualized by the hardware in this embodiment, although they may be attained as the software executed by a microcomputer that includes a CPU and memories and is mounted on the access point 10.

(A2) Wireless Network

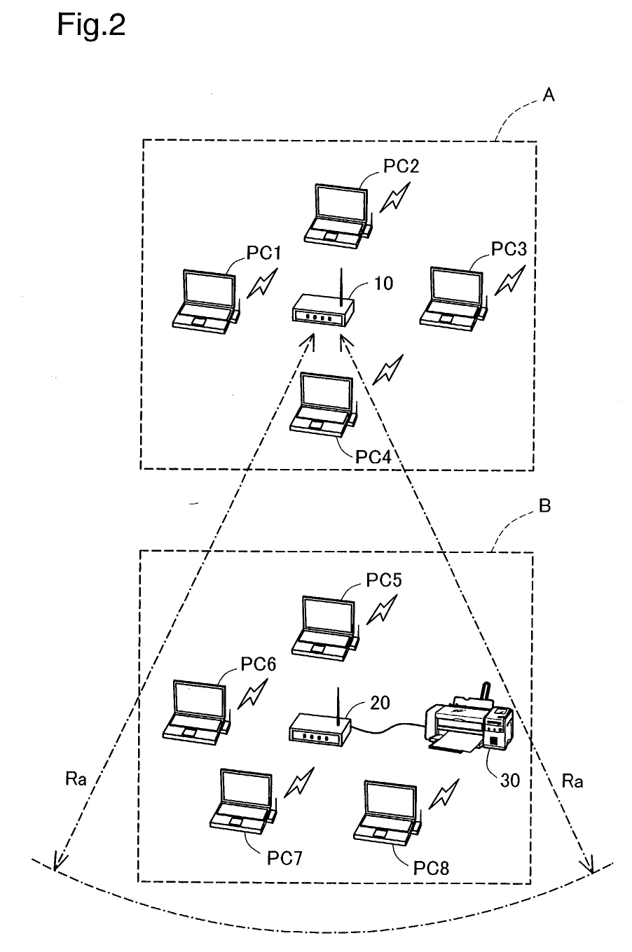

FIG. 2 shows a channel conflict state in two wireless networks. A wireless network A includes the access point 10 and stations PC1 through PC4. A wireless network B includes a wireless print server 20, a printer 30, and stations PC5 through PC8. The stations PC1 through PC8 are personal computers with wireless LAN cards respectively installed therein. The wireless print server 20 spools print jobs transmitted by wireless from each station and controls printing operations of the printer 30 connected by cable. The wireless print server 20 of this embodiment has such printer controlling functions, as well as the functions similar to those of the access point 10. The wireless print server 20 may thus function as an access point. The details of the wireless print server 20 will be discussed later.

Here it is assumed, for example, that a communication range or coverage of the access point 10 is in a circle of Ra in radius. When the wireless print server 20 also functions as an access point 10, the wireless print server 20 has a communication range like the access point 10. In this case, the communication ranges of the access point 10 and the wireless print server 20 overlap each other, so that adoption of an identical channel in both of the wireless networks A and B causes conflict of the channel and lowers the baud rate. When detecting such a trouble, the access point 10 carries out a channel conflict avoidance process discussed below.

(A3) Conflict Avoidance Process

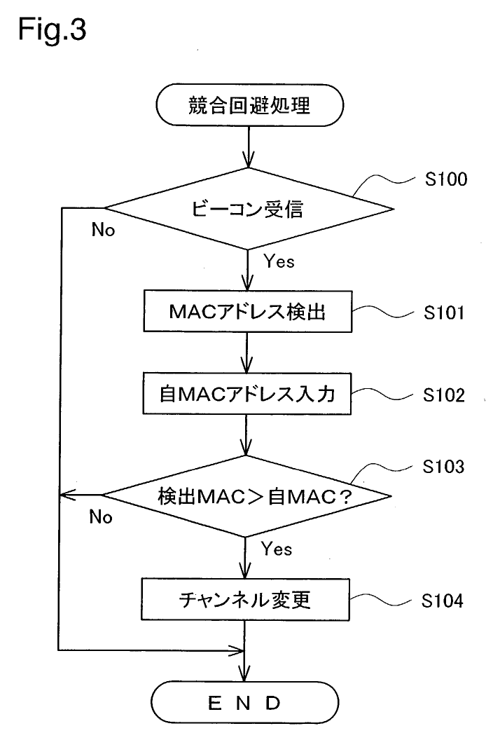

FIG. 3 is a flowchart showing a conflict avoidance process. This process is executed by both the access point 10 and the wireless print server 20 also functioning as an access point. The following description regards a series of processing executed by the access point 10.

The access point 10 first determines whether or not the wireless communication module 100 receives a beacon signal transmitted from another device (step S100). In the case of reception of the beacon signal, the access point 10 determines that there is a conflict of the channel and analyzes the received beacon signal to detect the MAC address of the wireless print server 20 (hereafter referred to as the ‘detected MAC address’) (step S101). In the case of no reception of the beacon signal at step S100, on the other hand, the access point 10 determines that there is no conflict of the channel and immediately exits from this processing routine.

The access point 10 inputs the MAC address stored in the MAC address storage module 104 (hereafter referred to as the ‘own MAC address’) (step S102), and compares the value of the detected MAC address with the value of the own MAC address (step S103). The MAC address represents numerical information allocated uniquely to every network device, so that the magnitude relation is specified unequivocally.

When the value of the detected MAC address is greater than the value of the own MAC address, the access point 10 changes its communication channel (step S104). When it is determined at step S103 that the value of the detected MAC address is smaller than the value of the own MAC address, on the other hand, the access point 10 assumes that the wireless print server 20 would change its communication channel and keeps the current setting of the channel.

The above series of processing is also executed by the wireless print server 20. When it is determined at step S103 that the value of the MAC address of the access point 10 is greater than the value of the MAC address of the wireless print server 20, the wireless print server 20 accordingly changes its channel. Multiple wireless communication devices mutually carry out the above series of conflict avoidance process, so as to avoid a trouble in communication, such as the lowered baud rate due to adoption of the conflicting channel. The determination of requirement or non-requirement of changing the channel according to the magnitude relation of the address value is a rule set between the multiple wireless communication devices. The channel may be changed according to the inverse relation, that is, by the device having the greater address value.

The new setting of the channel is arbitrarily selectable at step S104, but it is desirable to detect in advance a channel that does not conflict with any channels of other wireless communication devices as the new channel. For example, one available procedure successively searches other channels and sets a channel with no presence of beacon signals as the new channel. In the case where beacon signals are present in every channel, the procedure may select a channel receiving the least number of beacon signals per unit time, for example, a channel of the highest baud rate.

The series of processing discussed above determines requirement or non-requirement of changing the channel, based on comparison of the MAC address. A beacon signal, an IP address, a serial number assigned to each device, or an ID arbitrarily allocated by the user may be used instead of the MAC address. The object of comparison is not restricted to a numerical value like the address but may be a character string. Comparison of the character string is attained, for example, as comparison of the order of character codes assigned to the characters included in the character string or as comparison of the number of character strings. The character string used here may be a character string representing an ESS-ID included in the beacon signal.

B. Second Embodiment

The first embodiment regards the arrangement of changing the communication channel in the case of conflict of the channel. A second embodiment describes an arrangement of changing the communication mode.

(B1) General Construction of Wireless Print Server

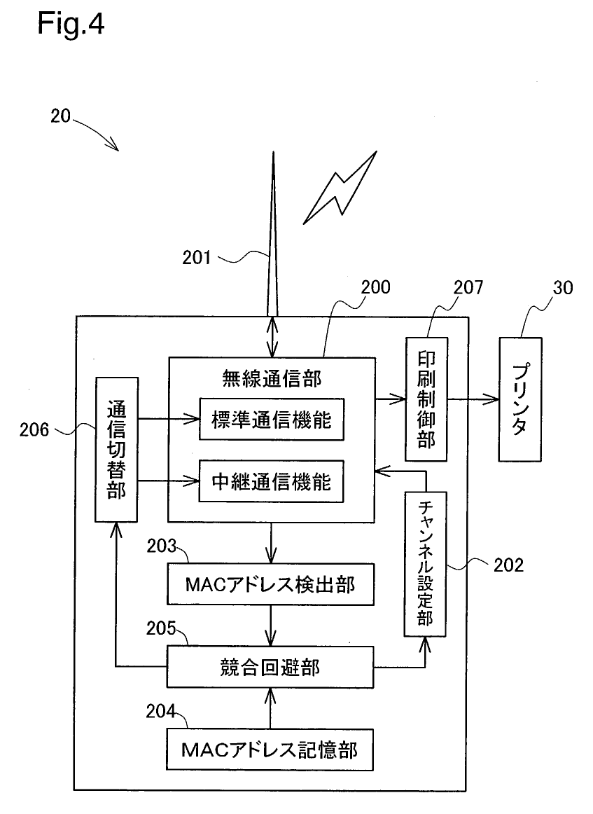

FIG. 4 schematically illustrates the construction of the wireless print server 20. The wireless print server 20 includes a wireless communication module 200, an antenna 201, a channel setting module 202, an MAC address detection module 203, an MAC address storage module 204, a conflict avoidance module 205, a communication switchover module 206, and a print control module 207.

The wireless communication module 200 uses a channel set by the channel setting module 202 to transmit and receive radio signals via the antenna 201. The wireless communication module 200 also receives beacon signals output from other access points.

The wireless communication module 200 has a standard communication function and a relay communication function. The standard communication function actuates the wireless communication module 200 as a station. The relay communication function actuates the wireless communication module 200 as an access point that relays communication from diverse wireless communication devices.

The MAC address detection module 203 analyzes the beacon signal received by the wireless communication module 200 to detect the MAC address of a transmission source like another access point. The MAC address storage module 204 stores an MAC address allocated uniquely to the wireless print server 20 at the time of factory shipment.

The conflict avoidance module 205 gives the communication switchover module 206 an instruction of making a switchover between the standard communication function and the relay communication function. The communication switchover function 206 switches over the type of communication actuated in the wireless communication module 200, in response to the given switchover instruction.

The print control module 207 spools print jobs transmitted from other wireless communication devices and received by the wireless communication module 200 and controls printing operations of the printer 30 connected by cable.

(B2) Conflict Avoidance Process

The wireless print server 20 of this embodiment switches over the type of communication from the relay communication function to the standard communication function to avoid conflict of the channel. The conflict avoidance process is discussed below.

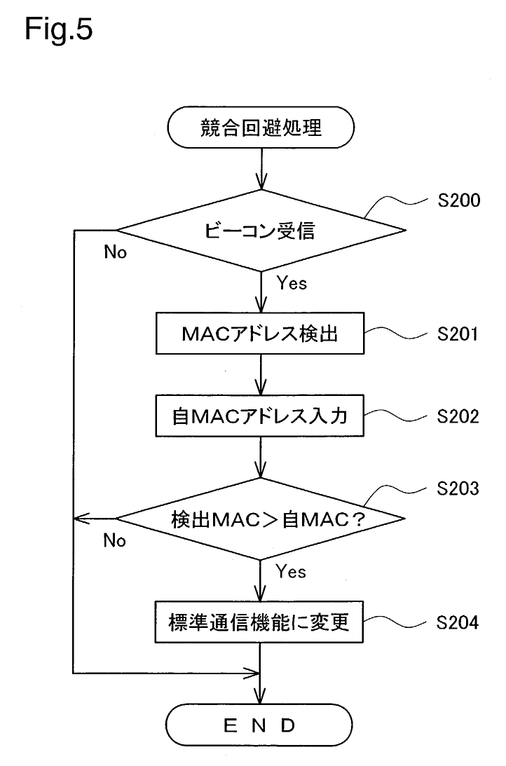

FIG. 5 is a flowchart showing the conflict avoidance process executed in this embodiment. The processing of steps S200 through S203 is identical with the processing of steps S100 through S103 in the conflict avoidance process of the first embodiment. At step S204, the wireless print server 20 changes the type of communication to the standard communication function, when the result of comparison of the address value at step S203 shows that the value of the MAC address of another access point (‘detected MAC’ in the flowchart) is greater than the value of the MAC address of the wireless print server 20 (‘own MAC’ in the flowchart). The wireless print server 20 accordingly stops the functions as an access point and starts functioning as a station. This enables one access point to control all the communication at the corresponding communication channel and thereby avoids conflict of the channel.

C. Modified Examples

Some examples of available modification of the above embodiments are given below.

(1) The conflict avoidance process is not restricted to the case of the conflicting channel but is applicable to the case of detection of the lowered baud rate or the increased density of beacon signals received per unit time.

(2) The conflict of the channel may be detected by exclusive communication for conflict avoidance, instead of the beacon signal. The identification information, such as the MAC address, may be detected from a packet like TCP/IP used for standard communication.

(3) The conflict avoidance process is also applicable to wireless communication in conformity with standards other than the standard IEEE 802.11, for example, wireless communication according to a frequency hopping method. When some trouble of communication is detected, the process may specify a device as an object of a conflict avoidance operation based on the MAC address or another equivalent information and carry out the adequate conflict avoidance operation, for example, change the timing of frequency hopping or the order of frequency to be hopped.

D. Third Embodiment

(D1) Construction of Wireless LAN

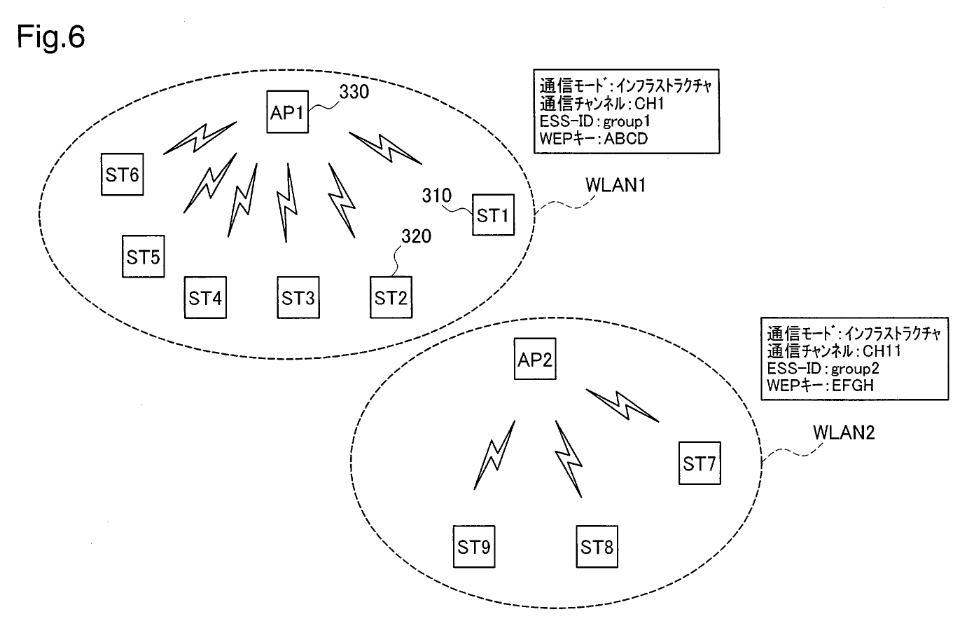

FIG. 6 shows the construction of wireless LANS. This embodiment regards wireless LANs in conformity with the international standard IEEE 802.11. As illustrated, a wireless LAN WLAN1 includes an access point AP1 (330) and six stations ST1 through ST6. Another wireless LAN WLAN2 includes an access point AP2 and three stations ST7 through ST9. Each of these devices functions as a wireless communication device.

The WLAN1 and WLAN2 establish wireless communication in an infrastructure mode, that is, in a communication mode making wireless communication via the corresponding access point AP1 or access point AP2. Settings in the WLAN 1 are a communication channel ‘CH1’, an ESS-ID ‘group 1’ as identification information used to identify a group establishing wireless communication, and a WEP key ‘ABCD’ used for cipher communication. Settings in the WLAN2 are a communication channel ‘CH11’, an ESS-ID ‘group 2’, and a WEP key ‘EFGH’.

The communication ranges of the WLAN1 and the WLAN2 overlap each other, so that the communication channels ‘CH1’ and ‘CH11’ are set in mutually non-interfering frequency bands.

The station ST1 is a personal computer 310, and the station ST2 is a wireless print server 320 connecting with a printer. Each of the stations ST1 through ST9 is capable of switching over the setting of communication mode to an Ad-hoc mode to attain direct wireless communication between the respective stations ST1 through ST9 without going through the access points AP1 and AP2. The personal computer 310 has a CPU, a RAM, a ROM, and a wireless LAN card. A utility software program for the wireless LAN card is installed in the personal computer 310. In the description hereafter, this personal computer 310 is referred to as the wireless communication device 310.

(D2) Wireless communication Device

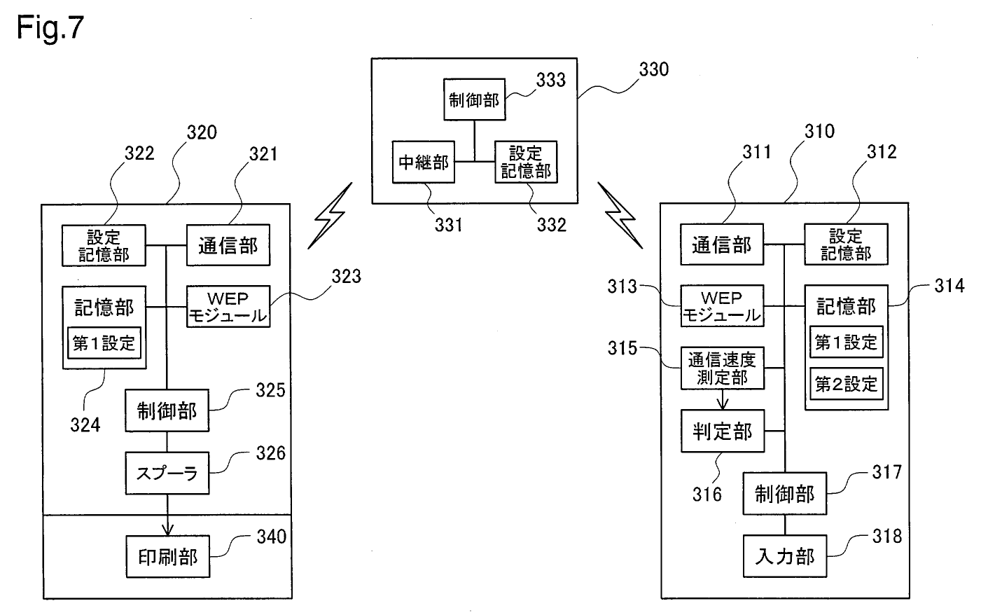

FIG. 7 schematically illustrates the construction of the wireless communication device 310 and the wireless print server 310 in the third embodiment of the present invention. Each of the wireless communication device 310, the wireless print server 320, and the access point 330 has a control unit including a CPU, a ROM, and a RAM. The respective functional blocks are attained as the software by execution of programs stored in the ROM by the CPU, although these functional blocks may be constructed by the hardware.

A memory module 314 of the wireless communication device 310 stores two sets of parameters required for wireless communication, that is, first settings and second settings. The first settings represent parameters for ordinary communication, and the second settings represent parameters for temporary communication. The temporary communication is utilized in the case of the occurrence of any trouble in communication or for the purpose of preventing a potential trouble in communication. The first settings and the second settings are as follows:

First Settings: Communication Mode: Infrastructure Mode

Communication Channel: CH1

ESS-ID: group 1

WEP key: ABCD

Second Settings: Communication Mode: Ad-hoc Mode

Communication Channel: CH6

WEP key: ABCD

The communication channel ‘CH6’ in the second settings is included in a frequency band that interferes with neither the communication channel ‘CH1’ in the first settings nor the communication channel ‘CH11’ in the WLAN2. The memory module 314 corresponds to the changed settings memory module and the settings storage module of the present invention.

A settings memory module 312 stores the settings actually used for communication between the first settings and the second settings. Namely the settings memory module 312 stores the first settings in the case of ordinary wireless communication, while storing the second settings in the case of temporary wireless communication.

A WEP module 313 encrypts and decrypts data with the WEP key ‘ABCD’ stored in the settings memory module 312. A communication module 311 divides encrypted data into packets and transmits the divided packets from the wireless LAN card, based on the parameters stored in the settings memory module 312. Namely the communication module 311 functions as a device driver of controlling the wireless LAN card.

A baud rate measurement module 315 measures the baud rate of packet communication. A decision module 316 determines whether or not a switchover of the settings for communication is required according to the baud rate measured by the baud rate measurement module 315.

An input module 318 inputs instructions from a keyboard, a mouse, and the like. A control module 317 controls the respective modules discussed above. The control module 317 further controls the related modules to transmit a switchover trigger, which is used to trigger a switchover of the settings for communication, and the second settings to the wireless print server 320, when the decision module 316 determines that the switchover of the settings for communication is required. The control module 317 also functions as the switchover module and the re-switchover module of the present invention.

The wireless print server 320 includes a communication module 321, a settings memory module 322, a WEP module 323, a memory module 324, a control module 325, and a spooler 326.

The memory module 324 stores in advance the first settings described above. The memory module 324 corresponds to the settings storage module of the present invention. The memory module 324 also stores the second settings, when receiving the second settings from the wireless communication device 310. The settings memory module 322 stores the settings actually used for communication between the first settings and the second settings. The settings memory module 322 stores the first settings in the case of ordinary wireless communication, while storing the second settings in the case of temporary wireless communication.

The communication module 321 receives the packets transmitted from the wireless communication device 310 and combines the received packets, based on the parameters stored in the settings memory module 322. The communication module 321 also functions as the instruction input module of the present invention.

The WEP module 323 encrypts and decrypts data with the WEP key stored in the settings memory module 322. The spooler 326 attains the main functions of a print server, such as holding, management, and output of print jobs to a printing module 340. The control module 325 controls the respective modules discussed above. The control module 325 also functions as the switchover module and the re-switchover module of the present invention.

The access point 330 includes a relay module 331, a settings memory module 332, and a control module 333. The control module 333 controls the relay module 331 and the settings memory module 332. The settings memory module 332 stores the first settings discussed above. The relay module 331 uses the first settings to relay wireless communication between the six stations including the wireless communication device 310 and the wireless print server 320.

(D3) Switchover of Communication Settings

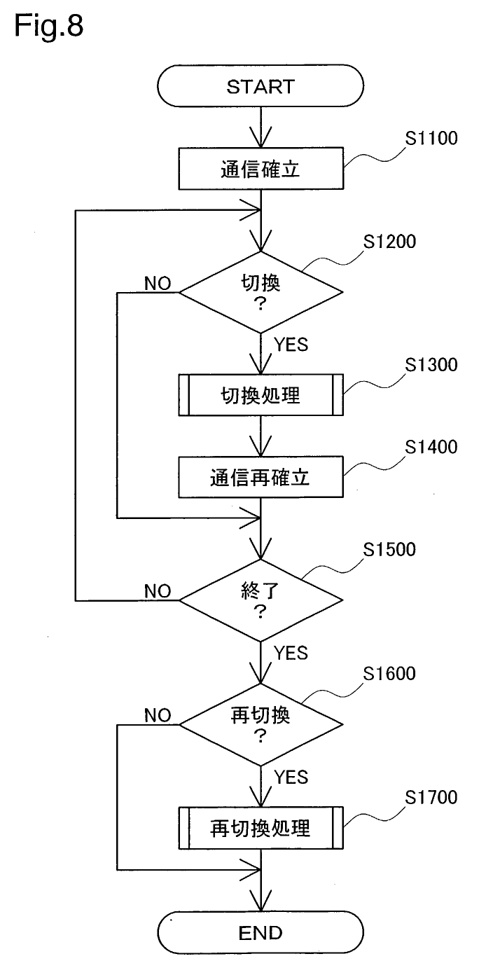

FIG. 8 is a flowchart showing a wireless communication process between the wireless communication device 310 and the wireless print server 320, which is executed by the wireless communication device 310. The wireless communication device 310 first uses the first settings and establishes wireless communication with the wireless print server 320 via the access point 330 (step S1100). The wireless communication device 310 then determines whether or not a switchover of the settings for communication is required, according to the baud rate (step S1200). When the baud rate is reduced to or below a preset level, the wireless communication device 310 determines that a switchover of the settings for communication is required and carries out a switchover process discussed below (step S1300).

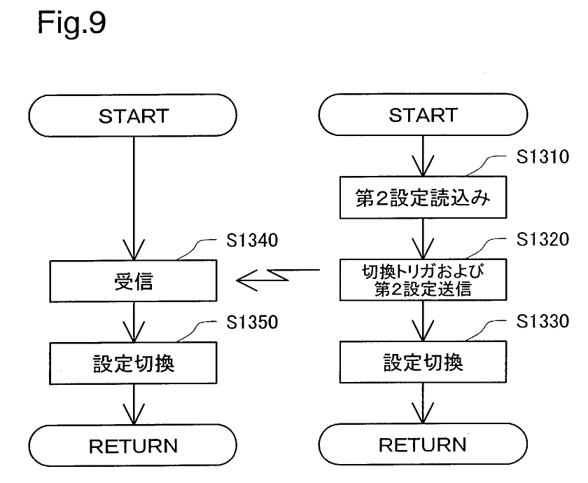

FIG. 9 is a flowchart showing the switchover process of switching over the settings for communication. The right half shows a series of processing executed by the wireless communication device 310, whereas the left half shows a series of processing executed by the wireless print server 320. The wireless communication device 310 reads the second settings from the memory module 314 (step S1310) and transmits a switchover trigger with regard to the settings for communication and the second settings to the wireless print server 320 (step S1320). This transmission is attained through the ordinary wireless communication based on the first settings. After the transmission, the wireless communication device 310 switches over the storage contents of the settings memory module 312 to the second settings (step S1330). The subsequent communication is accordingly carried out based on the second settings. In the structure of this embodiment, the memory module 314 stores the second settings in advance, so that the storage contents of the settings memory module 312 can readily be switched over at a high speed.

The wireless print server 320 receives the transmitted switchover trigger and second settings (step S1340) and switches over the contents of the settings memory module 312 to the second settings (step S1350). The wireless print server 320 can thus get into communication based on the second settings.

On completion of the above series of processing, the wireless communication device 310 and the wireless print server 320 establish wireless communication with the second settings (step S1400 in FIG. 8).

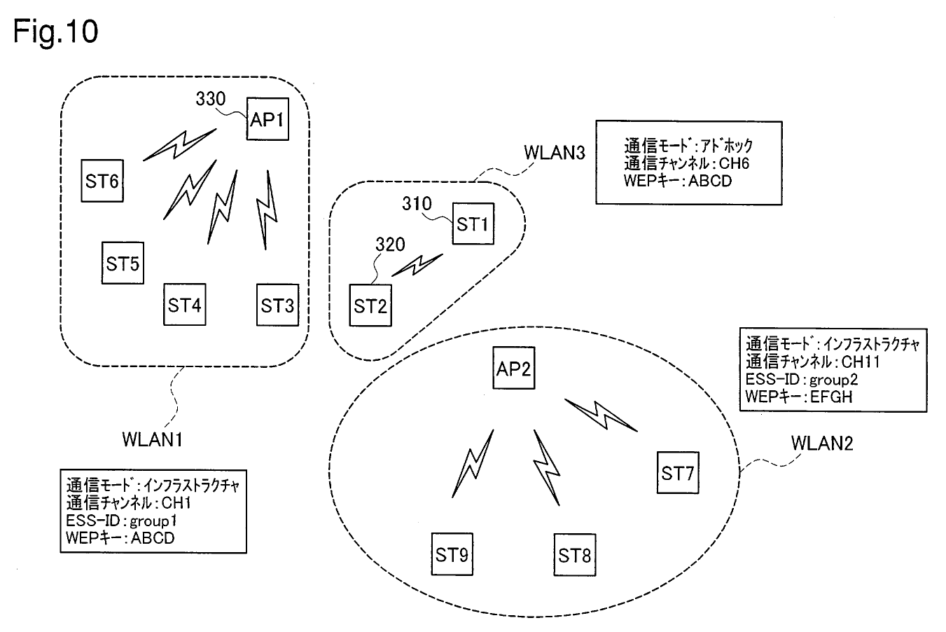

FIG. 10 shows a communication state of wireless LANs after re-establishment of wireless communication in the third embodiment. In this embodiment, the second settings are ‘communication mode: Ad-hoc mode, communication channel: CH6, WEP key: ABCD’ as mentioned previously. The wireless communication device 310 and the wireless print server 320 accordingly construct a new wireless LAN (WLAN3) that establishes wireless communication in the Ad-hoc mode. The communication channel ‘CH6’ in the second settings is included in a frequency band that interferes with neither the communication channel ‘CH1’ in the WLAN1 nor the communication channel ‘CH11’ in the WLAN2, thus ensuring a sufficiently high baud rate.

Referring back to the flowchart of FIG. 8, when it is determined at step S1200 that the switchover of the settings for communication is not required, that is when the baud rate is greater than the preset level, the wireless communication device 310 continues wireless communication with the wireless print server 320 based on the first settings. The wireless communication device 310 subsequently determines whether or not wireless communication in a predetermined unit is completed with either the first settings or the second settings (step S1500). The procedure of this embodiment determines whether or not wireless communication has been completed to the last packet of one print job. On completion of wireless communication to the last packet, the wireless communication device 310 determines wither or not a re-switchover of the settings for communication is required, that is, whether or not the second settings are to be re-switched over to the first settings (step S1600). In the case where no switchover has been effectuated at steps S1300 and S1400, the wireless communication device 310 determines that no re-switchover is required and terminates the wireless communication. When it is determined that the re-switchover is required, on the other hand, the wireless communication device 310 carries out a re-switchover process (step S1700).

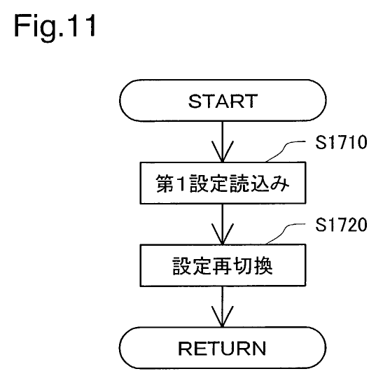

FIG. 11 is a flowchart showing the re-switchover process. The wireless communication device 310 and the wireless print server 320 respectively read the first settings from the memory module 314 and the memory module 324 (step S1710), and switches over the contents of the settings memory module 312 and the contents of the settings memory module 322 to the first settings (step S1720). The re-switchover process enables the wireless communication device 310 and the wireless print server 320 to establish wireless communication with another device in the WLAN1 based on the first settings.

As described above, the wireless communication device 310 and the wireless print server 320 of the third embodiment temporarily switch over the settings for communication from the first settings to the second settings in response to a decrease in baud rate, and establish one-to-one wireless communication at a mutually non-interfering communication channel. This arrangement thus ensures the sufficiently high baud rate in wireless communication between the wireless communication device 310 and the wireless print server 320. On completion of wireless communication between the wireless communication device 310 and the wireless print server 320, the settings for communication are re-switched over from the second settings to the first settings. This allows the wireless communication device 310 and the wireless print server 320 to establish wireless communication with another device in the original WLAN1.

(D4) Various Applications of Invention

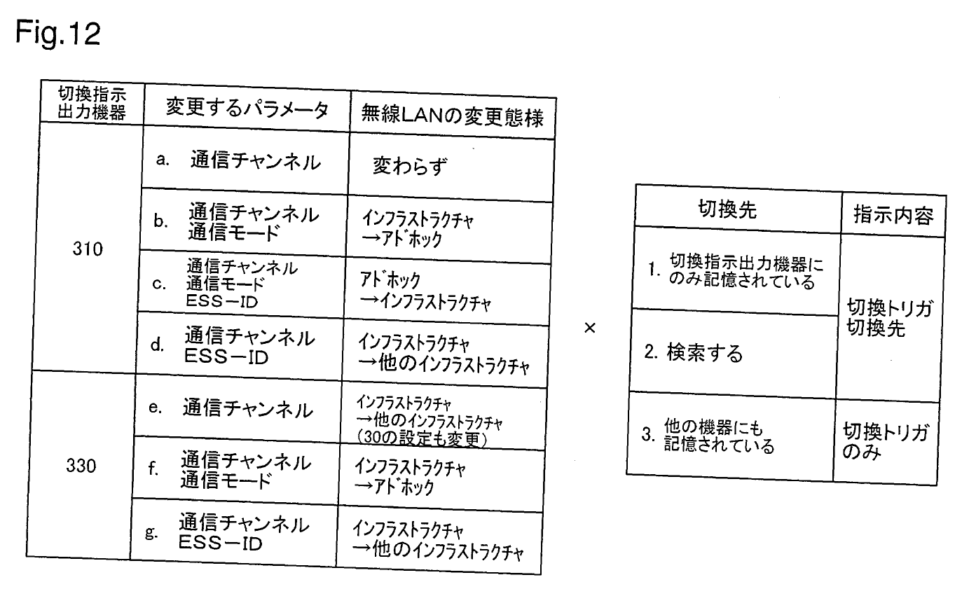

FIG. 12 shows various applications of the present invention. The technique of this invention is attainable by diverse combinations of the device outputting the switchover trigger of the communication settings, the parameters of the communication settings to be changed, and the device storing in advance the second settings used after the switchover. The change in parameters of the communication settings always accompanies a switchover of the communication channel.

As shown in the table, there are two devices outputting the switchover trigger of the communication settings:

(1) wireless communication device 310; and

(2) access point 330.

The access point 330 outputs the switchover trigger only while establishing wireless communication in the infrastructure mode.

When the wireless communication device 310 outputs the switchover trigger, there are four optional switchovers as the parameters of the communication settings to be changed:

(a) a switchover of only the communication channel (to switch over the communication channel while keeping the communication mode unchanged in the Ad-hoc mode or in the infrastructure mode);

(b) a switchover of the communication channel and the communication mode (to switch over from the infrastructure mode to the Ad-hoc mode using a different communication channel);

(c) a switchover of the communication channel, the communication mode, and the ESS-ID (to switch over from the Ad-hoc mode to the infrastructure mode using a different communication channel); and

(d) a switchover of the communication channel and the ESS-ID (to switch over from the infrastructure mode to another infrastructure mode using a different communication channel).

When the access point 330 outputs the switchover trigger, there are three optional switchovers as the parameters of the communication settings to be changed:

(e) a switchover of only the communication channel (to switch over the communication channel used for wireless communication among the wireless communication device 310, the wireless print server 320, and the access point 330 and construct a wireless LAN in another infrastructure mode);

(f) a switchover of the communication channel and the communication mode (to make the wireless communication device 310 and the wireless print server 320 establish wireless communication in the Ad-hoc mode using a different communication channel); and

(g) a switchover of the communication channel and the ESS-ID (to make the wireless communication device 310 and the wireless print server 320 establish wireless communication in a wireless LAN in another infrastructure mode using a different communication channel).

In each of the above combinations, there are three methods of specifying the communication channel in the second settings:

(1) The communication channel in the second settings is stored in advance only in the device outputting the switchover trigger;

(2) The device outputting the switchover trigger retrieves the communication channel; and

(3) The communication channel in the second settings is stored in advance not only in the device outputting the switchover trigger but in another device.

The switchover trigger and the switchover destination are output to another device in the cases (1) and (2), whereas only the switchover trigger is output in the case (3). Each of the combinations (a) through (g) discussed above may adopt any of the methods (1) through (3) with regard to the switchover destination.

As clearly understood from the above description, the third embodiment corresponds to the combination of (b) and (1). The following describes a combination of (d) and (3) (fourth embodiment), a combination of (f) and (3) (fifth embodiment), and a combination of (e) and (2) (sixth embodiment). A seventh embodiment regards the structure where one access point has multiple relay devices.

E. Fourth Embodiment

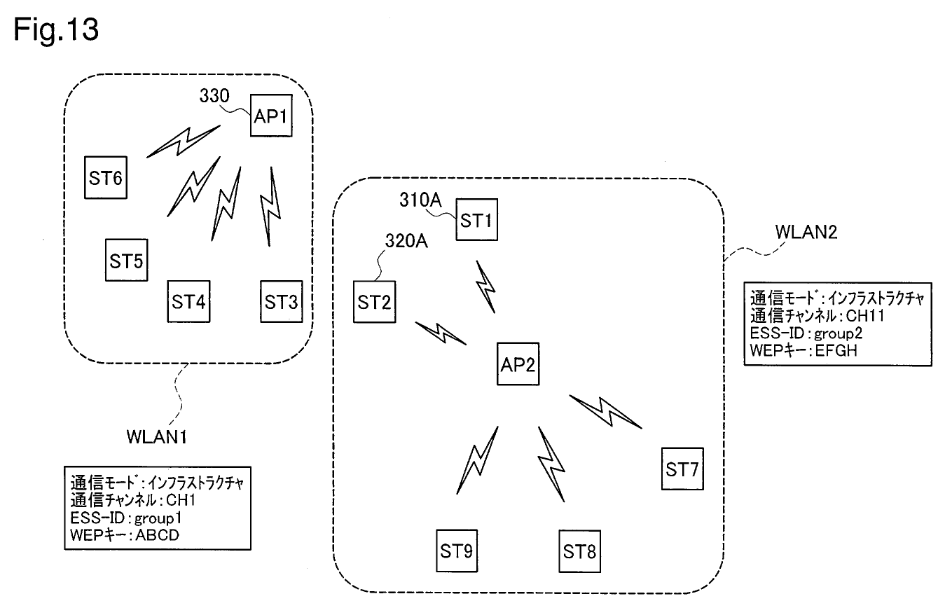

FIG. 13 shows a communication state of wireless LANs after the re-establishment of wireless communication (step S1400 of FIG. 8) in the fourth embodiment. In the structure of the fourth embodiment, the communication settings for connecting with the WLAN2 are used as the second settings as described below. A wireless communication device 310A and a wireless print server 320A are accordingly connected to the WLAN2 after the switchover of the communication settings at step S1300 of FIG. 8. This arrangement ensures the sufficiently high baud rate, as long as the WLAN2 has the good communication state.

In the structure of the fourth embodiment, in order to attain such wireless communication, the second settings have been stored in advance in a memory module of the wireless communication device 310A and in a memory module of the wireless print server 320A. The residual structure of the fourth embodiment is substantially similar to the structure of the third embodiment. Each memory module stores the ‘communication mode: infrastructure mode, communication channel: CH11, ESS-ID: group 2, WEP key: EFGH’ as the second settings. These communication settings are used for connection with the WLAN2.

The wireless communication device 310A establishes wireless communication according to the flowchart of FIG. 8. When its decision module determines that a switchover of the settings for communication is required at step S1200 of FIG. 8, the wireless communication device 310A transmits only a switchover trigger to the wireless print server 320A at step S1320 of FIG. 9.

The wireless print server 320A executes the switchover process of the communication settings according to the flowchart of FIG. 9, except that the second settings used at step S1350 are read from its memory module.

The series of processing other than the switchover process of the communication settings is identical with that of the third embodiment. In the structure of the fourth embodiment, the second settings have been stored in advance in the memory module of the wireless print server 320A. The wireless communication device 310A is thus not required to transmit the second settings to the wireless print server 320A in the process of switching over the communication settings. Namely this arrangement simplifies the instruction of switching over the communication settings in the wireless print server 320A.

F. Fifth Embodiment

In the structure of the fifth embodiment, after re-establishment of wireless communication, a wireless communication device 310B and the wireless print server 320A establish wireless communication in the same state as that of the third embodiment shown in FIG. 10. The difference is that the wireless communication device 310 outputs a switchover trigger of the communication settings in the third embodiment, while an access point 330A outputs the switchover trigger in the fifth embodiment.

In the structure of the fifth embodiment, in order to attain such wireless communication, the access point 330A has a baud rate measurement module and a decision module, as well as a memory module for storing the second settings, although the memory module is not essential.

The second settings have been stored in advance in memory modules of the wireless communication device 310B and the wireless print server 320A. The wireless communication device 310B has a structure similar to that of the third embodiment, except the structure has neither the baud rate measurement module nor the decision module. The respective memory modules store the ‘communication mode: Ad-hoc mode, communication channel: CH6, WEP key: ABCD’ as the second settings. The second settings of this embodiment are identical with the second settings of the third embodiment.

In the structure of this embodiment, the access point 330A carries out a series of processing substantially similar to the series of processing executed by the wireless communication device 310A in the fourth embodiment. When the decision module determines that a switchover of the settings for communication is required at step S1200 of FIG. 8, the access point 330A transmits only a switchover trigger to the wireless communication device 310B and the wireless print server 320A at step S1320 of FIG. 9. No switchover of the communication settings is, however, carried out in a settings memory module of the access point 330A, but the access point 330A continues the relay operations in the WLAN1. The wireless communication device 310B and the wireless print server 320A execute a series of processing identical with the series of processing executed by the wireless print server 320A in the fourth embodiment. The series of processing other than the switchover process of the communication settings in this embodiment is identical with that of the third embodiment.

G. Sixth Embodiment

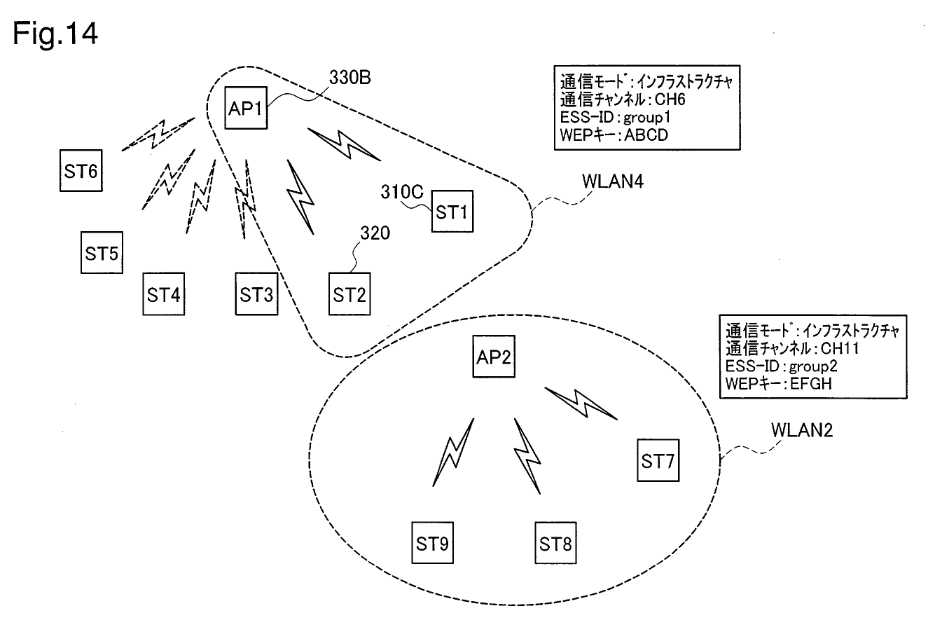

FIG. 14 shows a communication state of wireless LANs after re-establishment of wireless communication in the sixth embodiment. In the structure of the sixth embodiment, a switchover process of the communication settings switches over all the communication channels set in settings memory modules of a wireless communication device 310C, the wireless print server 320, and an access point 330B as described below. These devices accordingly construct a new wireless LAN (WLAN4). This arrangement enables the respective devices to establish wireless communication at a communication channel in the good communication state, thus ensuring the sufficiently high baud rate.

In the structure of the sixth embodiment, in order to attain such wireless communication, the access point 330B has a retrieval module to retrieve the communication channel in the good communication state, other than the constituents of the access point 330A in the fifth embodiment. The retrieval of such a communication channel is implemented, for example, by measuring the baud rate and retrieving a communication channel having a sufficiently high baud rate. Another applicable procedure detects the number of devices establishing wireless communication at an identical communication channel and retrieves a communication channel used by the least number of devices.

None of memory modules of the wireless communication device 310C, the wireless print server 320, and the access point 330B stores the second settings. Namely the second settings have not been stored in advance in the structure of this embodiment. The residual structure of this embodiment is identical with that of the fifth embodiment.

In the switchover process of the communication settings executed by the access point 330B of this embodiment, when the decision module determines that a switchover of the communication settings is required, based on the baud rate measured by the baud rate measurement module, the retrieval module retrieves the communication channel in the good communication state. Here it is assumed that ‘CH6’ is retrieved as the communication channel in the good communication state. The access point 330B then transmits a switchover trigger and the retrieved communication channel ‘CH6’ to the wireless communication device 310C and the wireless print server 320. The wireless communication device 310C and the wireless print server 320 switch over only the communication channel, in response to the switchover trigger. The access point 330B also switches over only the communication channel. In the structure of this embodiment, since the settings for communication in the access point 330B are switched over, the access point 330B temporarily becomes unable to relay wireless communication in the WLAN1. The series of processing other than the switchover process of the communication settings in this embodiment is identical with that of the third embodiment.

H. Seventh Embodiment

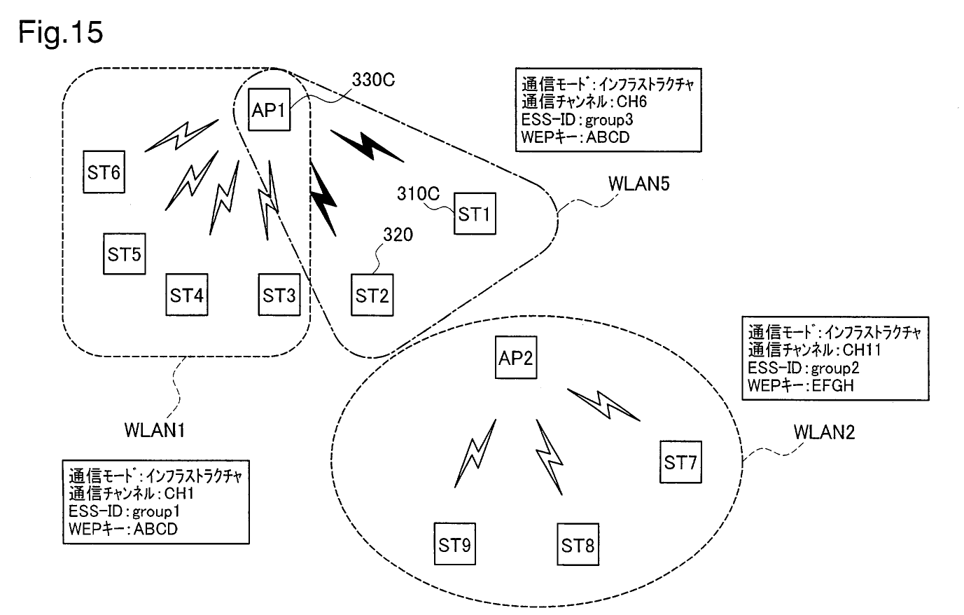

FIG. 15 shows a communication state of wireless LANs after re-establishment of wireless communication in the seventh embodiment. An access point 330C is capable of using multiple communication channels to simultaneously relay multiple wireless communications. The access point 330C has a first relay module to use settings for communication stored in a first settings memory module and relay wireless communication in a wireless LAN WLAN1, and a second relay module to use settings for communication stored in a second settings memory module and relay wireless communication in another wireless LAN (WLAN5). This arrangement ensures the sufficiently high baud rate in wireless communication between the wireless communication device 310C and the wireless print server 320.

The access point 330C of the seventh embodiment has the second relay module and the second settings memory module, in addition to the constituents of the access point 330A of the fifth embodiment. A second memory module stores the communication settings used to establish wireless communication via the second relay module. The communication settings stored in the second settings memory module correspond to the second settings in the third through the fifth embodiments discussed above. The communication settings stored in the second settings memory module are the ‘communication mode: infrastructure mode, communication channel: CH6, ESS-ID: groups 3, WEP key: ABCD’. The communication settings are used in the wireless LAN (WLAN5). The wireless communication device 310C and the wireless print server 320 are identical with those of the sixth embodiment.

In this embodiment, the wireless communication device 310C and the wireless print server 320 first establish wireless communication via the first relay module of the access point 330C. In the process of switching over the communication settings, the access point 330C transmits a switchover trigger and the communication settings stored in the second memory module to the wireless communication device 310C and the wireless print server 320. The wireless communication device 310C and the wireless print server 320 switch over the communication settings in the respective settings memory modules, in response to the switchover trigger. This arrangement enables the wireless communication device 310C and the wireless print server 320 to establish wireless communication via the second relay module.

The wireless communication device 310C and the wireless print server 320 of this embodiment are identical with those of the sixth embodiment, but may otherwise be identical with the wireless communication device 310B and the wireless print server 320A of the fifth embodiment. The same contents as those of the second settings memory module of the access point 330C have been stored in advance as the second settings in the respective memory modules of the wireless communication device 310B and the wireless print server 320A. In this case, the access point 330C is not required to transmit the communication settings to be effectuated after the switchover in the process of switching over the communication settings, but is required to transmit only the switchover trigger.

I. Modified Examples

I1. Modified Example 1

In the third through the seventh embodiments discussed above, the switchover condition of the communication settings is based on the baud rate. But this is not restrictive at all. For example, the switchover condition of the communication settings may be based on the communication protocol or the MAC address, the IP address, or the name of the communication partner. This arrangement also desirably relieves a potential increase in traffic in the wireless LAN and prevents an undesirable decrease in baud rate.

I2. Modified Example 2

In the switchover process of the communication settings in the third through the fifth embodiments discussed above, when the wireless print server has the functions of the access point, the communication settings may be switched over to allow the wireless print server to function as an access point.

I3. Modified Example 3

In the structures of the third through the fifth embodiments, multiple communication settings may be provided as optional communication settings after the switchover and may be selectively used in a flexible manner.

In the structure of the fifth embodiment, the access point 330C has two relay modules. The access point 330C may have a greater number of relay modules.

I4. Modified Example 4

In the embodiments discussed above, the wireless communication devices (personal computers), the wireless print servers, and the access points are used as the wireless communication devices of the present invention. These are, however, not restrictive in any sense. The technique of the present invention is also applicable to other wireless servers.

I5. Modified Example 5

The above embodiments regard the wireless LANs in conformity with the international standard IEEE 802.11. The technique of the present invention is, however, also applicable to wireless LANs in conformity with other standards.

What is claimed is:

1. A wireless communication device, comprising:
an identification information storage module that stores identification information, which is used to identify said wireless communication device;
a channel setting module that sets a channel used for wireless communication;
a wireless communication module that establishes wireless communication at the channel set by said channel setting module;
a trouble detection module that detects a trouble in communication according to a radio signal received by said wireless communication module;
an identification information detection module that detects identification information of another wireless communication device, which has transmitted the radio signal, from the received radio signal; and
a trouble avoidance module that carries out a predetermined avoidance operation to avoid the detected trouble according to a preset condition, which is set based on a relation between the identification information stored in said identification information storage module and the detected identification information.

2. A wireless communication device in accordance with claim 1, wherein the identification information is numeric information, and the preset condition is set based on a magnitude relation of the identification information.

3. A wireless communication device in accordance with claim 1, wherein the preset avoidance operation gives said channel setting module a switchover instruction to another channel.

4. A wireless communication device in accordance with claim 1, wherein said wireless communication module has a terminal communication function to make communication as a terminal and a relay communication function to receive a radio signal output from another wireless communication device and transmit the received radio signal to another wireless communication device,
said wireless communication device further comprising:
a communication function switchover module that switches over a working communication function between the two communication functions,
the preset avoidance operation giving said communication function switchover module an instruction of switching over the working communication function from the relay communication function to the terminal communication function.

5. A recording medium in which a computer program for causing a computer to control a wireless communication device is recorded, said computer program causing a computer to attain:
an identification information input function of inputting identification information, which is use to identify said wireless communication device, from said wireless communication device;
a channel setting function of setting a channel for wireless communication used by said wireless communication device;
a trouble detection function of utilizing a radio signal received by said wireless communication device to detect a trouble in communication;
an identification information detection function of detecting identification information of another wireless communication device, which has transmitted the radio signal, from the received radio signal; and
a trouble avoidance function of making said wireless communication device carry out a predetermined avoidance operation to avoid the detected trouble according to a preset condition, which is set based on a relation between the input identification information and the detected identification information.

6. A wireless communication device, comprising:
a communication module that establishes wireless communication at a preset communication channel;
a decision module that determines whether or not a switchover condition, which is set relating to at least one of contents of the wireless communication and a state of the wireless communication, is fulfilled;
a switchover module that, when the switchover condition is fulfilled, makes a switchover from the preset communication channel to another communication channel and gives a switchover instruction to a partner of the wireless communication;
a settings storage module that stores settings relating to the preset communication channel at a time of the switchover; and
a re-switchover module that makes a re-switchover from the another communication channel to the preset communication channel stored in said settings storage module, when wireless communication in a predetermined unit is completed at the another communication channel.

7. A wireless communication device in accordance with claim 6, wherein the switchover condition is set based on a baud rate of the wireless communication.

8. A wireless communication device in accordance with claim 6, said wireless communication device further comprising:
a changed settings memory module that stores in advance settings relating to the another communication channel,
wherein said switchover module makes the switchover, based on the settings stored in the changed settings memory module.

9. A wireless communication device in accordance with claim 6, said wireless communication device further comprising:
a retrieval module that retrieves a communication channel of getting around the switchover condition, and
said switchover module uses the retrieved communication channel as the another communication channel.

10. A wireless communication device in accordance with claim 6, wherein said communication module establishes wireless communication in a preset communication mode,
said switchover module makes a switchover from the preset communication mode to another communication mode,
said settings storage module stores the preset communication mode, and
said re-switchover module makes a re-switchover to the preset communication mode.

11. A wireless communication device in accordance with claim 6, wherein said communication module utilizes preset identification information, which is used to identify a group as a subject of the wireless communication, to establish the wireless communication,
said switchover module makes a switchover from the preset identification information to another identification information,
said settings storage module stores the preset identification information, and
said re-switchover module makes a re-switchover to the preset identification information.

12. A wireless communication device, comprising:
a communication module that establishes wireless communication at a preset communication channel;
a changed settings memory module that stores in advance settings relating to another communication channel as a switchover destination of the preset communication channel;
an instruction input module that inputs a switchover instruction of the preset communication channel from a partner of the wireless communication;
a switchover module that makes a switchover from the preset communication channel to the another communication channel, in response to the switchover instruction;
a settings storage module that stores settings relating to the preset communication channel at a time of the switchover; and
a re-switchover module that makes a re-switchover from the another communication channel to the preset communication channel stored in said settings storage module, when wireless communication in a predetermined unit is completed at the another communication channel.

13. A wireless communication device, comprising:
a communication module that establishes wireless communication at a preset communication channel;
an instruction input module that inputs a switchover instruction of the preset communication channel and settings relating to another communication channel as a switchover destination of the preset communication channel from a partner of the wireless communication;
a switchover module that makes a switchover from the preset communication channel to the another communication channel, in response to the switchover instruction;
a settings storage module that stores settings relating to the preset communication channel at a time of the switchover; and
a re-switchover module that makes a re-switchover from the another communication channel to the preset communication channel stored in said settings storage module, when wireless communication in a predetermined unit is completed at the another communication channel.

14. A wireless communication device, comprising:
a relay module that relays wireless communication between two wireless communication devices at a preset communication channel;
a decision module that determines whether or not a switchover condition, which is set relating to at least one of contents of the wireless communication and a state of the wireless communication, is fulfilled; and
a switchover instruction module that, when the switchover condition is fulfilled, gives an instruction of making a switchover from the preset communication channel to another communication channel, to said two wireless communication devices.

15. A wireless communication device in accordance with claim 14, said wireless communication device further comprising:
a second relay module that is capable of relaying wireless communication at a communication channel, which is different from the preset communication channel of said relay module,
wherein the another communication channel is the communication channel of said second relay module.

16. A wireless communication device in accordance with claim 14, wherein said switchover instruction module gives an instruction of switching over a communication mode.

17. A wireless communication device in accordance with claim 14, wherein said switchover instruction module gives an instruction of switching over identification information, which is used to identify a group as a subject of the wireless communication.

18. A switchover control method of controlling switchover of a communication channel in a wireless communication device, said switchover control method comprising the steps of:
(a) establishing wireless communication at a preset communication channel;
(b) determining whether or not a switchover condition, which is set relating to at least one of contents of the wireless communication and a state of the wireless communication, is fulfilled;
(c) when the switchover condition is fulfilled, making a switchover from the preset communication channel to another communication channel and giving a switchover instruction to a partner of the wireless communication;
(d) storing settings relating to the preset communication channel at a time of the switchover; and
(e) making a re-switchover from the another communication channel to the stored communication channel in said settings storage module, when wireless communication in a predetermined unit is completed at the another communication channel.

19. A switchover control method of controlling switchover of a communication channel in a wireless communication device, said switchover control method comprising the steps of:
(a) providing in advance settings relating to another communication channel as a switchover destination of a preset communication channel;
(b) establishing wireless communication at the preset communication channel;
(c) inputting a switchover instruction of the preset communication channel from a partner of the wireless communication;
(d) making a switchover from the preset communication channel to the another communication channel, in response to the switchover instruction;
(e) storing settings relating to the preset communication channel at a time of the switchover; and
(f) making a re-switchover from the another communication channel to the stored communication channel, when wireless communication in a predetermined unit is completed at the another communication channel.

20. A switchover control method of controlling switchover of a communication channel in a wireless communication device, said switchover control method comprising the steps of:
(a) establishing wireless communication at a preset communication channel;
(b) inputting a switchover instruction of the preset communication channel and settings relating to another communication channel as a switchover destination of the preset communication channel from a partner of the wireless communication;
(c) making a switchover from the preset communication channel to the another communication channel, in response to the switchover instruction;
(d) storing settings relating to the preset communication channel at a time of the switchover; and
(e) making a re-switchover from the another communication channel to the stored communication channel, when wireless communication in a predetermined unit is completed at the another communication channel.

21. A switchover control method of controlling switchover of a communication channel in a wireless communication device, said switchover control method comprising the steps of:
(a) relaying wireless communication between two wireless communication devices at a preset communication channel;
(b) determining whether or not a switchover condition, which is set relating to at least one of contents of the wireless communication and a state of the wireless communication, is fulfilled; and
(c) when the switchover condition is fulfilled, giving an instruction of making a switchover from the preset communication channel to another communication channel, to said two wireless communication devices.

22. A recording medium in which a computer program for controlling switchover of a communication channel in a wireless communication device is recorded, said computer program causing a computer to attain the functions of:
making said wireless communication device establish wireless communication at a preset communication channel;
determining whether or not a switchover condition, which is set relating to at least one of contents of the wireless communication and a state of the wireless communication, is fulfilled;
when the switchover condition is fulfilled, making a switchover from the preset communication channel to another communication channel and giving a switchover instruction to a partner of the wireless communication;
storing settings relating to the preset communication channel at a time of the switchover; and
making a re-switchover from the another communication channel to the stored communication channel, when wireless communication in a predetermined unit is completed at the another communication channel.

23. A recording medium in which a computer program for controlling switchover of a communication channel in a wireless communication device is recorded, said computer program causing a computer to attain the functions of:
reading settings relating to another communication channel as a switchover destination of a preset communication channel;
making said wireless communication device establish wireless communication at the preset communication channel;
acquiring a switchover instruction of the preset communication channel from a partner of the wireless communication;
making a switchover from the preset communication channel to the another communication channel, in response to the switchover instruction;
storing settings relating to the preset communication channel at a time of the switchover; and
making a re-switchover from the another communication channel to the stored communication channel, when wireless communication in a predetermined unit is completed at the another communication channel.

24. A recording medium in which a computer program for controlling switchover of a communication channel in a wireless communication device is recorded, said computer program causing a computer to attain the functions of:
making said wireless communication device establish wireless communication at a preset communication channel;
acquiring a switchover instruction of the preset communication channel and settings relating to another communication channel as a switchover destination of the preset communication channel from a partner of the wireless communication;
making a switchover from the preset communication channel to the another communication channel, in response to the switchover instruction;
storing settings relating to the preset communication channel at a time of the switchover; and
making a re-switchover from the another communication channel to the stored communication channel, when wireless communication in a predetermined unit is completed at the another communication channel.

25. A recording medium in which a computer program for controlling switchover of a communication channel in a wireless communication device is recorded, said computer program causing a computer to attain the functions of:
making said wireless communication device relay wireless communication between two wireless communication devices at a preset communication channel;
determining whether or not a switchover condition, which is set relating to at least one of contents of the wireless communication and a state of the wireless communication, is fulfilled; and
when the switchover condition is fulfilled, giving an instruction of making a switchover from the preset communication channel to another communication channel, to said two wireless communication devices.
